(19) United States
(12) Patent Application Publication
(10) Pub. No.: US 2006/0272631 A1
(43) Pub. Date: Dec. 7, 2006

(54) De-icer

(76) Inventors: Carl Coke, Brooklyn, NY (US); Shara Coke, Brooklyn, NY (US)

Correspondence Address: Allan Chan & Associates, 46th Floor, 140 Broadway, New York, NY, 10005, US

(21) Appl. No.: 11/143,175

(22) Filed: Jun. 2, 2005

(51) Int. Cl. E02D 19/14; E01H 5/10; E01C 23/14; H05B 3/00

(52) U.S. Cl. 126/271.2 A; 37/227; 219/213; 405/131

(57) ABSTRACT

In accordance with the present invention, an apparatus for melting ice and snow which includes a pad means; a pump means; a heater means; a temperature regulation means; and a pump control means is disclosed. The pad means includes a top panel, a bottom panel and two end panels. The top panel has evenly spaced vertical integral channels which run the length of the pad means. The bottom panel has evenly spaced horizontal integral channels which run the width of the pad means. The vertical channels and the horizontal channels are in fluid communication with each other. The pad means is in fluid communication with the pump means and the heater means and is also in electrical communication with the temperature regulation means and the pump control means. The pump control means is in electrical communication with the pump means.

### BACKGROUND OF THE INVENTION

1. Field of the Invention

The invention is an apparatus for melting snow and ice. More particularly, it relates to a removable device for preventing and eliminating the accumulation of snow and ice on walkways, pavements, streets, runways, roads, thoroughfare, throughway, and driveways by heating means.

2. Description of the Related Art

Thus, what is needed then is an apparatus for melting and preventing the accumulation of snow and ice on walkways and driveways which is energy efficient, easily removable, decorative, versatile for all uses of roads or pavements.

In view of the prior art as a whole at the time the present invention was made, it was not obvious to those of ordinary skill in the pertinent art how the apparatus could be provided.

### SUMMARY OF THE INVENTION

In accordance with the present invention, an apparatus for melting ice and snow which includes a pad means; a pump means; a heater means; a temperature regulation means; and a pump control means is disclosed. The pad means includes a top panel, a bottom panel and two end panels. The top panel has evenly spaced vertical integral channels which run the length of the pad means. The bottom panel has evenly spaced horizontal integral channels which run the width of the pad means. The vertical channels and the horizontal channels are in fluid communication with each other. The pad means is in fluid communication with the pump means and the heater means and is also in electrical communication with the temperature regulation means and the pump control means. The pump control means is in electrical communication with the pump means.

The invention accordingly comprises the features of construction, combination of elements and arrangement of parts that will be exemplified in the description hereinafter set forth, and the scope of the invention will be indicated in the claims.

### BRIEF DESCRIPTION OF THE DRAWINGS

FIG. 1 is one implementation of the invention,

FIG. 2 is the lop view of the invention,

FIG. 3 is the top view of the invention, interchanging the top layer,

FIG. 4, 5, 6 is the profile of the drainage system in the invention,

FIG. 7 is the cross-sectional of the invention,

FIG. 8 is the cross-sectional side view of the invention,

FIG. 9 is the exploded cross-sectional side view of the invention,

FIG. 10 is the cross-sectional top view of the honeycomb embodiment,

FIG. 11 is the exploded top view of cell, and

FIG. 12 is the cross-sectional side view of the cell.

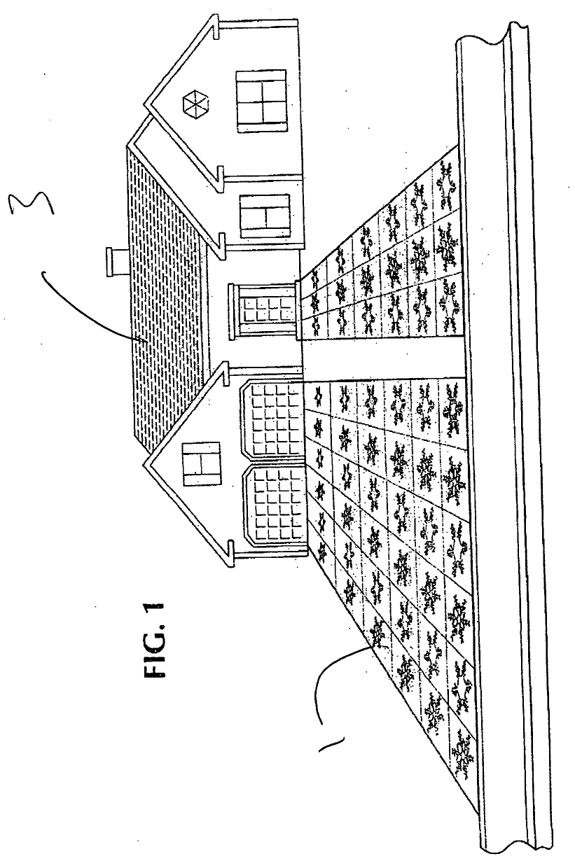

### DETAILED DESCRIPTION

The current invention 1 is intended to keep ice and snow off of surfaces in either residential or commercial settings. Such an invention 1 may be used in relations to residential driveways, walkways, etc. Essentially, on any outdoor surface that ice and snow is undesirable. Further, the current invention can be utilized in relations to commercial settings such as, but not limited to commercial store fronts, loading docks, airport runways, commercial parking areas, hospital emergency room entrances, etc. The current invention can be paved on top of any existing surface much like a mat. Nevertheless, the current invention is on a grander scale and can be firmly attached to any surface.

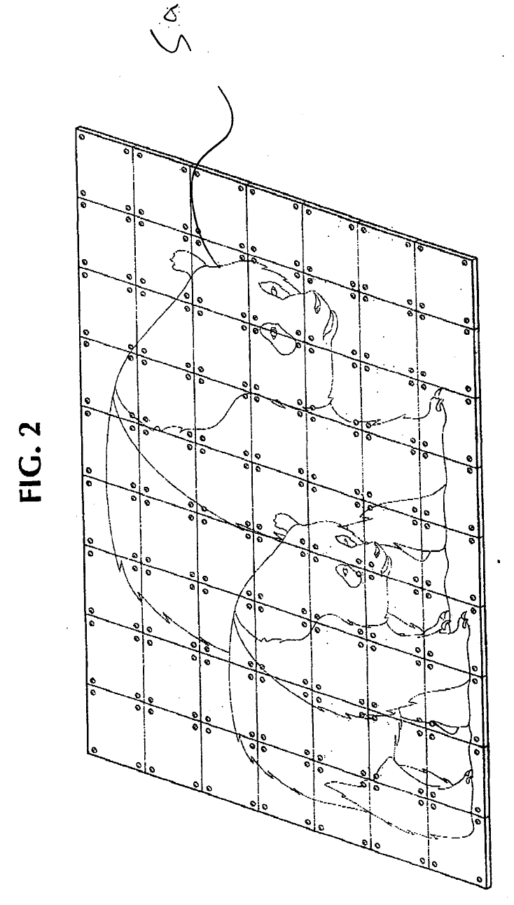

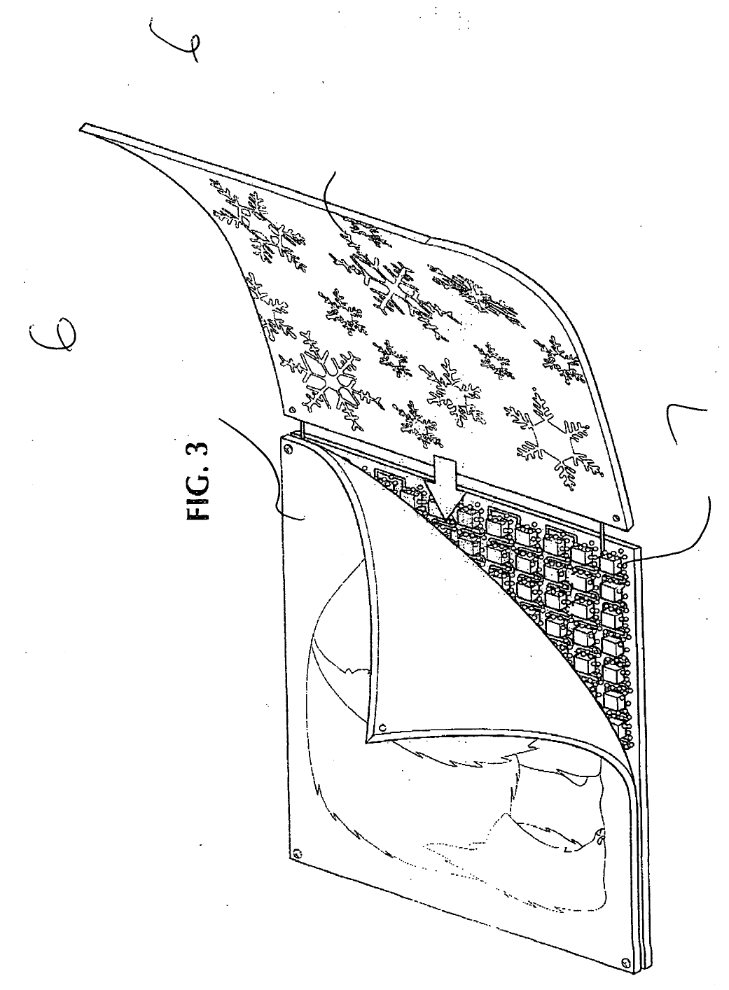

As shown in FIG. 2, residential uses, the current invention may have certain aesthetic designs 5. Such designs 5 can include but not limited to flowers, animals, sports related motifs, etc. In commercial settings, designs 5 can be in the form of advertisements to further inform consumers of certain products or services. As in FIG. 3 such top portion 6 of the current invention can be easily replaced due to either wear, or the users desire for an alternative design.

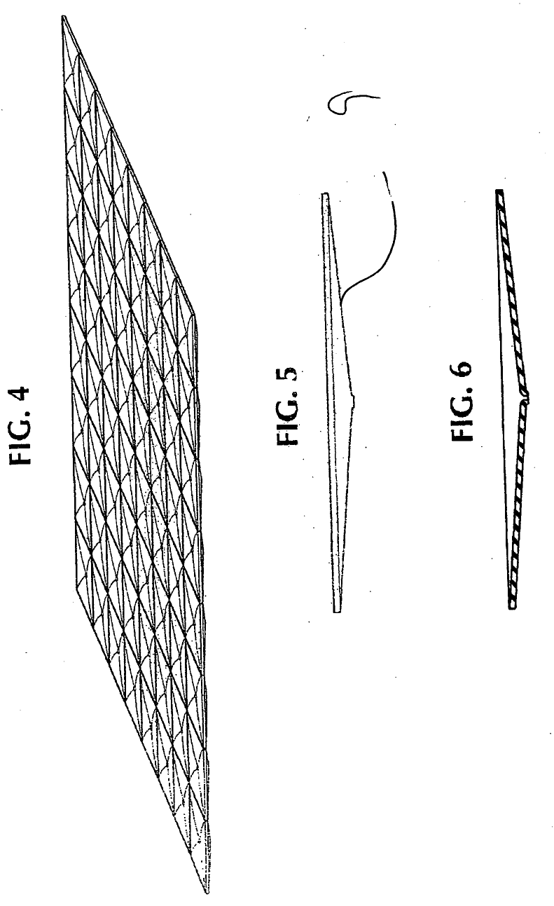

As shown in FIG. 4-6, at least one drain 9 is interspersed throughout the invention. The drains 9 are intended to allow the excess liquids resulting from the melting process to be evacuated. In one embodiment, each individual tile in the current invention retains a drain in the center. A slight gradient is utilized to allow gravity to drive the liquids into the drain 9. Alternatively, one drain 9 can be placed in the center of the whole device. The interposal of the drains 9 are dependent on the gradient angle. Ideally gradient angles should be such that safety is maintained at all times. Further, dependent on the commercial usages, larger gradients may not be feasible in relations to machinery, vehicles, etc. Additionally, support pillars 21 may be uniformly distributed throughout the system to bear any type of weighted load upon the current invention.

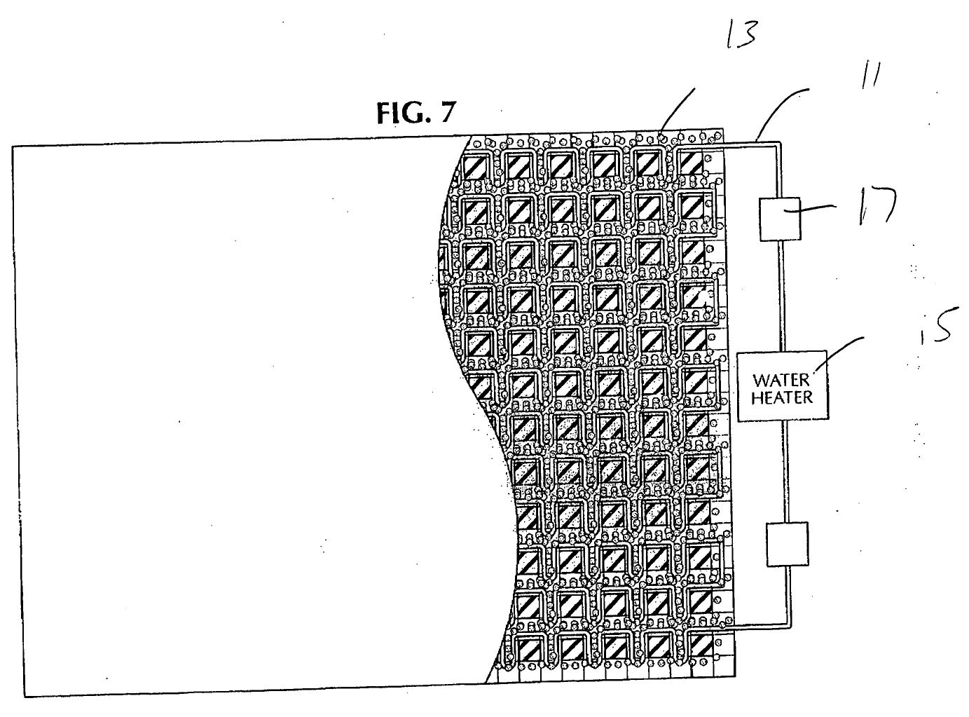

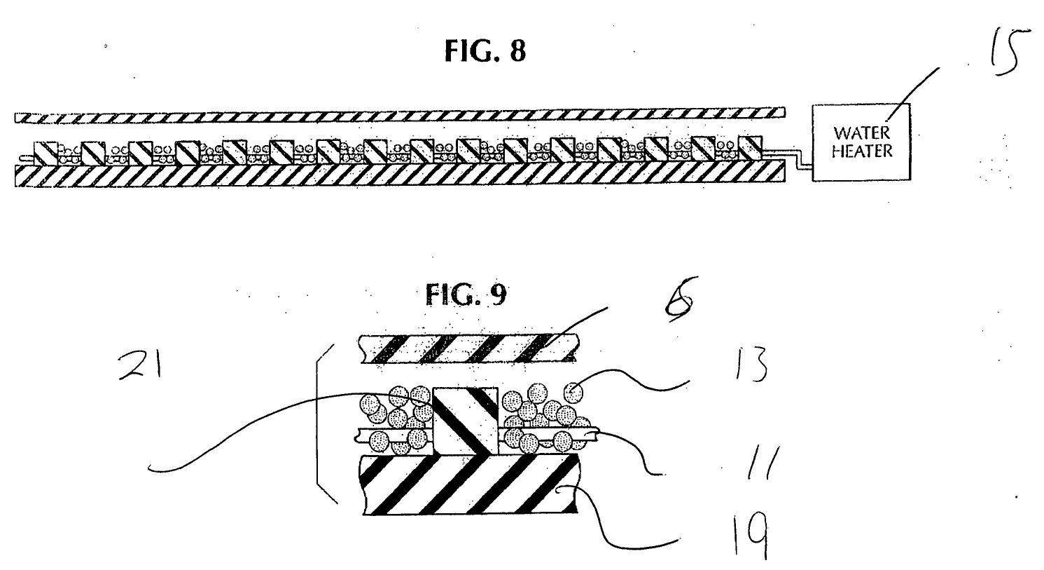

As shown in FIG. 7, the cross section of the invention reveals, as in one embodiment of the invention a circulatory system of pipes 11 to enable the fluid to be transversed throughout the invention. The pipes 11 are laid out in such a fashion that heat conduction is uniform throughout the entire surface area of the current invention. The liquids within the system are heated and circuited throughout the invention to enable the melting of snowing and ice on the surface of the invention. Liquids which can be used are nonflammable, high melting point liquids such as but not limited to oil, antifreeze, or any liquid polymer. In addition to the pipes 11, solids 13 are dispersed amongst the pipes to prevent excessive heat loss from the system. Such solids 13 may be made from materials such as but not limited to: ceramic, stone, heat retentive polymers, etc. The shape of the solids 13 are such that the surface area of the solids 13 arc in conductive contact at all times. The preferred shaped of such solids 13 arc spheres. The pump utilized in this invention can be of any commonly known in the art to circulate liquid of a certain density throughout the invention.

The hot oil-carrying heating pipe 11 is laid, in meander form, through these troughs above the laths, with the connecting bends of the pipe coil tightly looping the respective curved members, thus providing exactly parallel substantially rectilinear pipe ducts extending between the two supporting laths in the above-described arrangement. The laying of pipe 11 is, in this case, particularly simple, since the curved members form, with their troughs, a laying gauge, by which a plastic pipe, for example, can be laid under stress. The arrangement not only assures parallelism of the pipe coil rectilinear ducts interconnecting the pipe coil bends, but also a constant spacing of the pipe ducts connected by completely identical bends. The pipe coil thus laid is secured, over the entire range of the troughs, against falling out or displacement, for example by clamps.

In principle, the heating coil pipe 8 could consist of metal, but the laying of a plastic pipe is simpler, due to its greater flexibility. However, plastic pipes have the disadvantage that they are poor heat conductors. For this reason, it has been found particularly advantageous to add, to the plastic used to form the pipe 11, a metal powder, such as powdered aluminum or powdered copper. By this expedient, the thermal conductivity of the pipe can be considerably increased without substantially reducing its flexibility.

A further improvement of the heat transfer, and a particularly uniform heat distribution over the entire floor area, is attained by metal lamellae, Formed, for example, of copper or aluminum, and which are thermally connected with the parallel ducts of the pipe coil, by bridging the interval between adjacent pipe ducts. The mounting of these lamellae is particularly simple due to the constant spacing between the parallel pipe ducts of the pipe coil.

A liquid heater 15 may be in the form of a boiler as communing known in the art; which according to the present invention includes a combustion chamber arrangement disposed within a heat transfer system so as to cause heat or combustion from arrangement to be readily transferred into a fluid medium, such as oil, circulating through system. A heat conserving flue assembly is disposed above heat transfer system, and is arranged in communication with combustion chamber arrangement for absorbing heat from smoke, flue gases, and the like, being exhausted from arrangement. As will become clear below, a fluid medium, such as oil to be heated by the boiler is fed into flue assembly where the medium passes to eventual discharge from boiler so as to be permitted to circulate through the inner tubing 11 of the present invention.

Combustion chamber arrangement includes a solid fuel firebox generally in the form of a conventional fireplace firebox and provided with a stack extending vertically from the top of firebox. At least one liquid inlet tube extends into cavity so as to disposed along the extent of stack for conveying the fluid medium to be heated from pump 17 for discharge.

Flue assembly further includes a combustion product vent line communication with combustion area through divided passage and with annular space defined by concentric shells. A damper of conventional construction is provided at the 90-degree bend in line outwardly so as to selectively block and unblock an air passage. Since the purpose and operation of damper is as conventionally employed in gas burner venting systems, and the like, its operation will not be described in detail herein.

Heat transfer system includes a housing arranged partially surrounding firebox, leaving only the fire-building access opening thereto, and includes a bottom wall disposed substantially horizontally so as to form the base of a reservoir. A plurality of lateral ducts are provided extending horizontally across the upper portion of housing in order to form a flow path within housing of increased heat transfer surface relative to a fire within firebox. Extending horizontally across housing, substantially midway between an upper wall thereof and the bottom wall, is a baffle which partitions the reservoir. A passage system including a pair of pipes 11 is provided within housing, with the pipes 11 being arranged penetrating through the membrane formed by baffle and permitting the fluid medium being heated to be transferred from adjacent the top of housing to discharge.

Beneath wall of housing, and forming a base for the portions of housing disposed thereabove, is the combustion area in which is disposed can be a conventional gas burner, and the like.

A suitable damper is disposed within the lower portion of stack for controlling the draft through the stack in a manner well known.

A boiler according to the present invention has the capability of burning combustible solids, liquids and gaseous fuels. The burning of combustible solids is set up for one chamber, specifically firebox, whereas the burning of combustible gases or liquids is provided in the other combustion chamber, specifically in the combustion areas. A discussion of the burners or controls needed therefore shall not be set forth herein, since such burners and their controls are well known and commonly employed. Nevertheless, it is understood that all controls and equipment used shall be capable of performing their task and shall be safety oriented. A further consideration is that a choice of fuels is only dependent on availability, desirability and economics. The ability to use different fuels made possible by a boiler according to the invention will allow the use of crop produced fuels such as wood-pulp, corncobs, and the like, with the advantage that when the user gets tired of firing manually, one can be assured that the unit will automatically begin to utilize gaseous or liquid fuels. Thus, energy is being conserved together with a resulting reduction in cost to the user. That is, the multi-fuel capability of boiler 10 allows use of the most fuel available. Prudent fuel storage assures heating ability even during disasters.

As one embodiment, using an oil medium for pumped heat transfer, the heat extraction process begins in the highest extraction chamber or cavity which forms a water jacket around stack. Also, heat is extracted from combustion products passing upwardly in cavity which, in effect, forms a second exhaust stack. After absorbing the heat in this chamber, or reservoir part, the oil overflows the top of this heat stage by way of the overflow control pipes to the bottom of the heat stage below it. After the heat absorption occurs within this chamber, reservoir part, the hot oil either overflows into the bottom of an additional heat stage below it by way of another overflow control tube or flows out of the system through a discharge port. That is, the discharge of the heated medium may be performed from the top of any of the heat extraction chambers provided. Any number of such heat extraction stages may be employed, their size and shape being regulated by the application desired. Thus, each heat extraction stage absorbs its optimum heat and acts as a heat boosting principle to the next extraction stage below it. This principle also allows the application of different temperatures of hot water, dependent to one's need. This principle is also applicable to the largest industrial application needs. The essentials being compartmented water jackets with control tubing to direct pump water flow to obtain maximum heat absorption and efficiency.

Elements of the inventions can be comprised partly or entirely of recycled materials. Further, timers can be utilized with the current invention. The user can set the duration or heating per day and the time of day to initiate the heating/melting process. Further as commonly known in the art, the current invention can be liked to sophisticated automated home central control systems. In one embodiment, the user can turn on the current invention through the use of a cell phone. Additional sensors internal to the system are utilized to monitor the internal workings of the system. Thermal sensors are utilized to regulate the temperature of the liquid. Breakage sensors may be utilized to notify the user any breakages of the system. Flow sensors may also be utilized to detect any event of blockages in the system.

Repairs to the system may be done by removing sections of the current invention in the form of tiles.

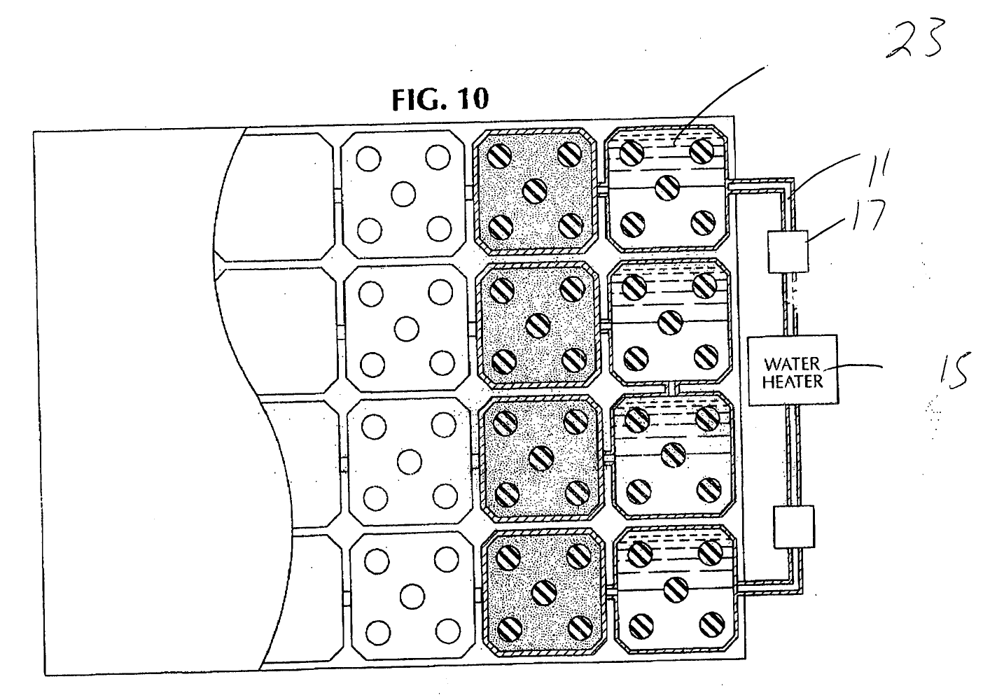

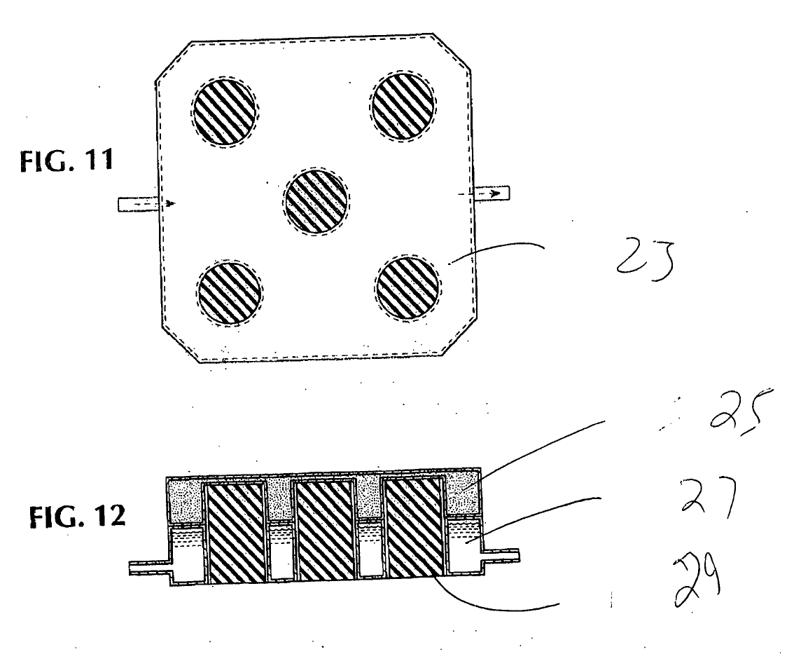

An alternative embodiment of the invention, as shown in FIG. 10, utilizes a honeycomb system instead of utilizing pipes. Such honeycomb system can also be used with the heat retentive solids 13. The liquids are pumped throughout the cells of the honeycomb 23.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below

1. An apparatus for removing ice and snow from a pavement comprising
a. Fluid being traversed throughout the area of the apparatus;
b. At least one heating device to warm the circulating fluid;
c. A multiplicity of heat conductive and retentive solids interspersed throughout the surface area of the apparatus; and
d. At least one thermostat to control the temperature of the heating device.

2. An apparatus for removing ice and snow from a pavement comprising
a. Fluid being traversed throughout the area of the apparatus;
b. At least one heating device to warm the circulating fluid;
c. A multiplicity of heat conductive and retentive solids interspersed throughout the surface area of the apparatus;
d. At least one thermostat to control the temperature of the heating device; and
e. A decorative design on the surface of the apparatus.

3. An apparatus for removing ice and snow from a pavement comprising
a. Fluid being traversed throughout the area of the apparatus;
b. At least one heating device to warm the circulating fluid;
c. A multiplicity of heat conductive and retentive solids interspersed throughout the surface area of the apparatus;
d. At least one thermostat to control the temperature of the heating device; and
e. The apparatus is laid over the existing surface of any size, in the form of interchangeable tiles.

4. An apparatus for removing ice and snow from a pavement comprising
a. Fluid being traversed throughout the area of the apparatus;
b. At least one heating device to warm the circulating fluid;
c. A multiplicity of heat conductive and retentive solids interspersed throughout the surface area of the apparatus;
d. At least one thermostat to control the temperature of the heating device;
e. A decorative design on tile surface of the apparatus; and
f. The apparatus is laid over the existing surface of any size, in the form of interchangeable tiles.

5. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus; and
g. The apparatus is laid over the existing surface of any size, in the form of interchangeable tiles.

6. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles; and
h. Drains are positioned in areas of the apparatus to allow for drainage.

7. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage; and
i. A sensor is electronically connected onto the heating device to engage the apparatus automatically.

8. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage; and
j. A sensor is electronically connected onto the heating device to engage the apparatus automatically.

9. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage;
j. A sensor is electronically connected onto the heating device to engage the apparatus automatically; and
k. The apparatus is anchored to the surface of the pavement.

10. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage;
j. A sensor is electronically connected onto the heating device to engage the apparatus automatically; and
k. Said apparatus is removable depending on season or personal desire.

11. An apparatus for removing Ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage;
j. At least one sensor is electronically connected onto the heating device to engage the apparatus automatically; and
k. At least one second sensor to detect breakages in the apparatus.

12. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids Interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage;
j. At least one sensor is electronically connected onto the heating device to engage the apparatus automatically; and
k. At least one remote control to engage the apparatus.

13. An apparatus for removing ice and snow from a pavement comprising
a. The outer shell of the apparatus being comprised of recycled materials;
b. Fluid being traversed throughout the area of the apparatus;
c. At least one heating device to warm the circulating fluid;
d. A multiplicity of heat conductive and retentive solids interspersed throughout the surface area of the apparatus;
e. At least one thermostat to control the temperature of the heating device;
f. A decorative design on the surface of the apparatus;
g. The apparatus is laid over the existing surface of any size, in the form of interchangeable tiles;
h. Drains are positioned in areas of the apparatus to allow for drainage;
i. Top surface of the apparatus is positioned in a gradient to allow for liquid drainage; and
j. At least one remote control to engage the apparatus.

14. An apparatus as in one of claims 1-13, in which load bearing support pillars are distributed equally throughout the apparatus.

15. An apparatus for removing ice or snow from a pavement comprising:
a. Pressurized fluid being traversed throughout the internal cavity of the apparatus;
b. At least one heating device to warm the circulating fluid;
c. A multiplicity of heat conductive and retentive solids interspersed throughout the internal cavity of the apparatus;
d. At least one thermostat to control the temperature of the heated liquid; and
e. At least one support column to bear the weight placed open the apparatus.

16. The apparatus according to claim 1, wherein a decorative design is on a top surface of the apparatus;

17. The apparatus according to claim 1, wherein the apparatus is laid aver the existing surface of any size, in the form of interchangeable tiles.

18. The apparatus according to claim 1, wherein a decorative design is on a top surface of the apparatus; and the apparatus is laid aver the existing surface of any size, in the form of interchangeable tiles.

19. The apparatus according to claim 1, wherein the apparatus being comprised of recycled materials.

20. The apparatus according to claim 1, wherein at least one drain is positioned in areas of the apparatus to allow for surface drainage of liquid resulting of the removal of the ice or snow.

21. The apparatus according to claim 1, wherein at least one sensor is electronically connected ante the heating device to engage the apparatus automatically.

22. The apparatus according to claim 1, wherein at least one drain is positioned in areas of the apparatus to allow far surface drainage of liquid resulting from the removal of the ice or snow; the tap surface of the apparatus is positioned in a gradient to allow far liquid drainage; and at least one sensor is electronically connected ante the heating device to engage the apparatus automatically

23. The apparatus according to claim 1, wherein the apparatus is anchored to the surface of the pavement.

24. The apparatus according to claim 1, wherein said apparatus is removable depending on season or personal desire.

25. The apparatus according to claim 1, wherein the apparatus is anchored to the surface of the pavement; and said apparatus is removable depending on season or personal desire.

26. The apparatus according to claim 1, wherein at least one second sensor to detect breakages in the apparatus.

27. The apparatus according to claim 1, wherein the apparatus may be engaged remotely.

28. The apparatus according to claim 1, wherein the apparatus may be engaged and disengaged on a timer.

29. An apparatus for removing ice or snow from a pavement comprising:
a. Pressurized fluid being traversed throughout the internal cavity of the apparatus;
b. At least one heating-device to warm the circulating fluid;
c. A multiplicity of heat conductive and retentive solids interspersed throughout the internal cavity of the apparatus;
d. At least one thermostat to control the temperature of the heated liquid;
e. At least one support column to bear the weight placed open the apparatus;
f. the outer shell of the apparatus being comprised of recycled materials;
g. a decorative design on the surface of the apparatus;
h. the apparatus is laid over the existing surface of any size, in the form of interchangeable tiles; at least one drain is positioned in areas of the apparatus to allow for drainage;
i. top surface of the apparatus is positioned in a gradient to allow for liquid drainage; and
j. at least one remote control to engage the apparatus.

30. The apparatus according to claim 1, wherein the pavement is a highway.

31. The apparatus according to claim 1, wherein the pavement is a sidewalk.

32. The apparatus according to claim 1, wherein the pavement is a driveway.

33. The apparatus according to claim 1, wherein the pavement is a runway.

34. An apparatus for removing snow or ice from a pavement comprising:
a. The apparatus comprising an inner network of cells providing a conduit for fluids;
b. Pressurized Fluid being traversed throughout the inner network of cells of the apparatus;
c. At least one heating device to warm the circulating fluid;
d. A multiplicity of heat conductive and retentive solids interspersed throughout the surface area of the apparatus;
e. At least one thermostat to control the temperature of the heating device; and
f. At least one support column to bear the weight placed upon the apparatus.
